(19) United States
(12) Patent Application Publication
(10) Pub. No.: US 2011/0149766 A1
(43) Pub. Date: Jun. 23, 2011

(54) ASSOCIATION SUPPORTING APPARATUS AND METHOD IN WIRELESS COMMUNICATION SYSTEM

(75) Inventors: Eun-Young CHOI, Daejeon (KR); Jung-Bo SON, Daejeon (KR); Sok-Kyu LEE, Daejeon (KR)

(73) Assignee: Electronics and Telecommunications research Institute, Daejeon (KR)

(21) Appl. No.: 12/868,636

(22) Filed: Aug. 25, 2010

(30) Foreign Application Priority Data
Dec. 22, 2009 (KR) 10-2009-0128576

(51) Int. Cl. H04L 12/26

(52) U.S. Cl. 370/252

(57) ABSTRACT

An association supporting apparatus in a wireless communication system includes: a transmission/reception unit configured to scan associable access points (APs) among a plurality of APs existing in a plurality of station (STA) wireless networks, and receive state information from the scanned APs; a calculation unit configured to calculate transmit opportunity (TXOP) periods with respect to the APs by using the received state information of the APs; and a determination unit configured to determine a predetermined AP among the plurality of scanned APs, considering usable power levels of the APs and the number of associable STAs during the calculated TXOP periods.

### CROSS-REFERENCE(S) TO RELATED APPLICATIONS

The present application claims priority of Korean Patent Application No. 10-2009-0128576, filed on Dec. 22, 2009, which is incorporated herein by reference in its entirety.

### BACKGROUND OF THE INVENTION

1. Field of the Invention

Exemplary embodiments of the present invention relate to a wireless communication system; and, more particularly, to an association supporting apparatus and method which are capable of allowing a station (hereinafter, referred to as an STA) to be dynamically associated with an optimum access point (hereinafter, referred to an AP), depending on operation states of a plurality of APs, to thereby provide a communication service to a user at a high speed in a wireless communication system.

2. Description of Related Art

In general, a communication system is a system which performs information processing with an STA through a communication line, and there are a wired communication system and a wireless communication system. The wireless communication system is a system aimed to a moving object, for example, a person, a mobile public phone, and a vehicle. Examples of the wireless communication system include a wireless local area network (WLAN), a Bluetooth, and so on.

The WLAN is a near field communication network which can provide an ultra-high speed Internet within a predetermined distance from a place where an AP is installed. The AP performs a WLAN repeater function. In addition to the repeater function, the AP has a wired LAN hub function so that a wired port is embedded to connect a printer or a desktop computer, which is usually placed at a fixed position without requiring mobility, in a wired manner. An STA intended to be associated with the AP, for example, a personal digital assistant (PDA) and a notebook computer, is associated with the AP through the WLAN.

Meanwhile, the STA which provides a communication service to a user in the WLAN scans associable APs among a plurality of APs existing within the WLAN, and associates with a predetermined AP among the scanned APs. For example, the STA associates with an AP having a high reception rate of a response signal received from an AP with respect to a transmitted signal during the AP scanning, for example, an AP having an optimum channel state. In case where a plurality of STAs existing in the WLAN scan APs at the same time, the association of STAs may be concentrated on the predetermined AP among the scanned APs.

The number of STAs associable with a single AP in the WLAN is limited. As described above, when the association of STAs is concentrated on a single AP, some STAs may not be associated with the APs due to the limit in the number of associable STAs. The STAs which are not associated do not provide a smooth communication service due to association failure. Moreover, resources are wasted because the remaining APs except for the concentrated AP are not associated.

### SUMMARY OF THE INVENTION

An embodiment of the present invention is directed to an association supporting apparatus and method in a wireless communication system.

Another embodiment of the present invention is directed to association supporting apparatus and method in a wireless communication system, in which an STA can be dynamically associated with an optimum AP, depending on operation states of a plurality of APs, to thereby provide a communication service to a user at a high speed.

Another embodiment of the present invention is directed to association supporting apparatus and method in a wireless communication system, in which a plurality of STAs are associated with an optimum AP in distributed manner, depending on operation states of a plurality of APs.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an association supporting apparatus in a wireless communication system includes: a transmission/reception unit configured to scan associable access points (APs) among a plurality of APs existing in a plurality of station (STA) wireless networks, and receive state information from the scanned APs; a calculation unit configured to calculate transmit opportunity (TXOP) periods with respect to the APs by using the received state information of the APs; and a determination unit configured to determine a predetermined AP among the plurality of scanned APs, considering usable power levels of the APs and the number of associable STAs during the calculated TXOP periods.

In accordance with another embodiment of the present invention, an association supporting method in a wireless communication system includes: scanning associable APs among a plurality of APs existing in a plurality of STA wireless networks; receiving state information from the scanned APs; calculating TXOP periods with respect to the APs by using the received state information of the APs; determining a predetermined AP among the plurality of scanned APs, considering usable power levels of the APs and the number of associable STAs during the calculated TXOP periods; and associating with the determined AP and receiving a communication service.

### BRIEF DESCRIPTION OF THE DRAWINGS

FIG. 1 is a diagram schematically illustrating the architecture of an association supporting apparatus in a wireless communication system in accordance with an embodiment of the present invention.

FIG. 2 is a view schematically illustrating the procedure in which a transmission/reception unit 111 receives state information from APs 110, 120 and 130 when power levels used by an STA associated with the APs 110, 120 and 130 are equal to one another.

FIG. 3 is a view illustrating the usable power levels of the APs 110, 120 and 130.

FIG. 4 is a view illustrating the procedure in which the transmission/reception unit 111 receives the state information from the APs 110, 120 and 130 when the power levels used by the STA associated with the APs 110, 120 and 130 are not equal to one another.

FIG. 5 is a view illustrating a method for selecting a channel when the AP which the transmission/reception unit 111 intends to associate with uses multiple channels.

FIG. 6 is a flowchart schematically illustrating an association supporting method in a wireless communication system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Exemplary embodiments of the present invention are directed to an apparatus and method for providing data in a wireless communication system, for example, a WLAN system and an Institute of Electrical and Electronics Engineers (IEEE) 802.11 system. The following embodiments of the present invention are directed to association supporting apparatus and method in a wireless communication system, in which an STA can be dynamically associated with an optimum AP, depending on operation states of a plurality of APs, to thereby provide a communication service to a user at a high speed.

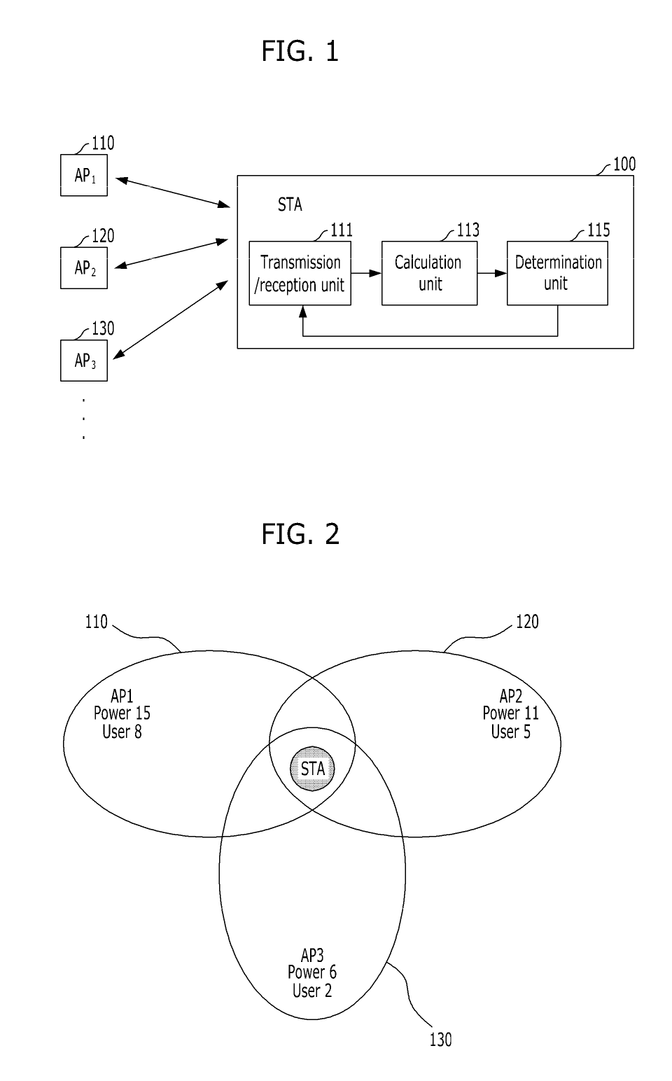

Furthermore, in association supporting apparatus and method in a wireless communication system in accordance with embodiments of the present invention, a plurality of STAs can be associated with an optimum AP in distributed manner, depending on operation states of a plurality of APs. An association supporting apparatus in a wireless communication system in accordance with an embodiment of the present invention will be described below in detail with reference to FIG. 1.

FIG. 1 is a diagram schematically illustrating the architecture of an association supporting apparatus in a wireless communication system in accordance with an embodiment of the present invention.

Referring to FIG. 1, the wireless data association supporting apparatus includes an STA 100 and a plurality of APs 110, 120 and 130. The STA 100 includes a transmission/reception unit 111, a calculation unit 113, and a determination unit 115. For convenience of explanation, it is assumed that a single wireless station, for example, the STA 100, scans the plurality of APs 110, 120 and 130 existing within a WLAN, associates with a single AP among the plurality of APs 110, 120 and 130, and transmits data thereto, and the APs 110, 120 and 130 use a single channel.

The APs 110, 120 and 130 perform a variety of functions, such as a wired LAN hub function, a bridge function, a home gateway function, and an automatic fall-back function. The bridge function allows communication between two buildings located far away. Also, the home gateway function allows association of information communication devices with an external network. The automatic fall-back function automatically lowers the transfer speed of the APs 110, 120 and 130 when a channel state is poor because the distance between the APs 110, 120 and 130 and the STA 100 is long.

The transmission/reception unit 111 scans the associable APs 110, 120 and 130 in order for association with the AP having the optimum state, and receives the state information from the scanned APs 110, 120 and 130. The transmission/reception unit 111 can scan the APs 110, 120 and 130 by using a passive scanning scheme or an active scanning scheme.

More specifically, when the transmission/reception unit 111 scans the associable APs 110, 120 and 130 by using the passive scanning method, the transmission/reception unit 111 requests state information to the APs 110, 120 and 130 by using a probe request message. The state information is information indicating usable power levels of the APs 110, 120 and 130 and the number of STAs associable with the APs 110, 120 and 130.

The APs 110, 120 and 130 receiving the probe request message transmit the requested state information to the transmission/reception unit 111 by using a probe response message. The transmission/reception unit 111 receives the state information through the probe response message and transmits the state information to the calculation unit 113. The calculation unit 113 calculates transmit opportunity (TXOP) periods with respect to the APs 110, 120 and 130 by using the received state information of the APs 110, 120 and 130.

The determination unit 115 determines the association with a predetermined AP among the scanned APs 110, 120 and 130, considering the usable power level of the APs 110, 120 and 130 and the number of the associable STAs in the TXOP periods calculated by the calculation unit 113. The predetermined AP refers to an AP having the maximum power level and the minimum associable STA during the calculated TXOP periods among the scanned APs 110, 120 and 130.

The predetermined AP determined by the determination unit 115 is transmitted to the transmission/reception unit 111, and the transmission/reception unit 111 associates with the predetermined AP determined by the determination unit 115 and receives a communication service.

When the transmission/reception unit 111 scans the associable APs 110, 120 and 130 by using the active scanning scheme, the APs 110, 120 and 130 contain their state information in a beacon message and transmit the beacon message containing the state information to the transmission/reception unit 111. The transmission/reception unit 111 receives the state information through the beacon message and transmits the state information to the calculation unit 113.

The calculation unit 113 calculates the TXOP periods with respect to the APs 110, 120 and 130 by using the received state information of the APs 110, 120 and 130. The determination unit 115 determines the association with a predetermined AP among the scanned APs 110, 120 and 130, considering the usable power level of the APs 110, 120 and 130 and the number of the associable STAs in the TXOP periods calculated by the calculation unit 113.

The predetermined AP refers to one of the scanned APs 110, 120 and 130 having the minimum TXOP period during the calculated TXOP periods. The predetermined AP determined by the determination unit 115 is transmitted to the transmission/reception unit 111, and the transmission/reception unit 111 associates with the predetermined AP determined by the determination unit 115 and receives a communication service. The procedure in which the transmission/reception unit 111 receives the state information from the APs 110, 120 and 130 when the power levels used by the STA associated with the APs 110, 120 and 130 are equal to one another will be described in more detail with reference to FIG. 2.

FIG. 2 is a view schematically illustrating the procedure in which the transmission/reception unit 111 receives the state information from the APs 110, 120 and 130 when the power levels used by the STA associated with the APs 110, 120 and 130 are equal to one another.

Referring to FIG. 2, the transmission/reception unit 111 scans the associable APs 110, 120 and 130 in order for association with the AP having the optimum state, and receives the state information from the scanned APs 110, 120 and 130. When the transmission/reception unit 111 scans the associable APs 110, 120 and 130 by using the passive scanning scheme, the transmission/reception unit 111 requests the state information to the APs 110, 120 and 130 by using the probe request message.

The state information is information indicating the usable power levels of the APs 110, 120 and 130 and the number of the STAs associable with the APs 110, 120 and 130. Using the probe response message, the transmission/reception unit 111 receives from the first AP 110 the state information indicating that the usable power level of the first AP 110 is 5 and the number of the STAs associable with the first AP 110 is 10.

Also, using the probe response message, the transmission/reception unit 111 receives from the second AP 120 the state information indicating that the usable power level of the second AP 120 is 4 and the number of the STAs associable with the second AP 120 is 8. Also, using the probe response message, the transmission/reception unit 111 receives from the third AP 130 the state information indicating that the usable power level of the third AP 130 is 3 and the number of the STAs associable with the third AP 130 is 1.

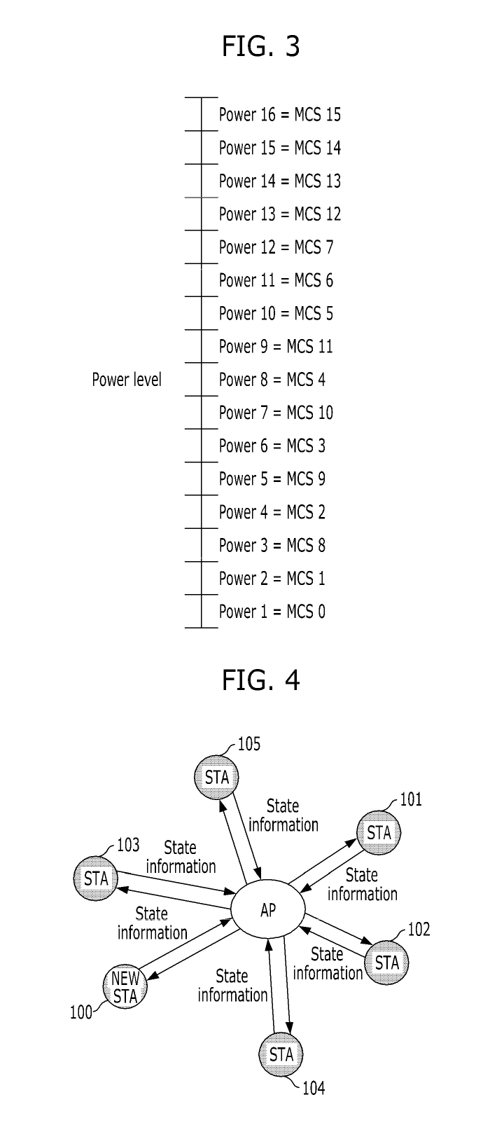

Then, the calculation unit 113 calculates the TXOP periods by using the usable power level of the APs 110, 120 and 130 and the number of the associable STAs of the APs 110, 120 and 130. The usable power levels are shown in FIG. 3. The determination unit 115 determines the association with the predetermined AP among the scanned APs 110, 120 and 130, considering the usable power levels of the APs 110, 120 and 130 and the number of the associable STAs during the calculated TXOP periods.

The predetermined AP determined by the determination unit 115 is transmitted to the transmission/reception unit 111, and the transmission/reception unit 111 associates with the predetermined AP determined by the determination unit 115 and receives a communication service. The structure of the usable power levels of the APs 110, 120 and 130 will be described in more detail with reference to FIG. 3.

FIG. 3 shows the structure of the usable power levels of the APs 110, 120 and 130.

Referring to FIG. 3, the usable power levels of the APs 110, 120 and 130 may be in the range of 1 to 16. Using Equation 1 below, the calculation unit 113 calculates the TXOP periods by using the received usable power levels of the APs 110, 120 and 130 and the number of the associable STAs of the APs 110, 120 and 130.

$$TXOP period = {U}_{N} \times ( ( \frac{{T}_{PREM} + {P}_{L}}{{N}_{SYM} \times 4 us} ) \times ( {P}_{N} - 1 ) + ( \frac{{T}_{PREM} + {P}_{L}}{{N}_{SYM} \times 4 us} ) + {T}_{SIFS} + {T}_{ACK} + {T}_{DIFS} + {T}_{BO} ) \qquad Eq . 1$$

In Equation 1 above, U_{N} represents state information received from the predetermined AP among the scanned associable APs 110, 120 and 130, that is, the number of the STAs associable with the APs 110, 120 and 130. T_{PREM} represents a preamble transmission time, and N_{SYM} represents the quantity of data which can be transmitted per symbol according to the determined power levels. P_{N} represents the number of entire packets determined according to the quantity of data which can be transmitted per symbol.

Also, P_{L} represents the length of the entire packets, and P_{LL} represents the length of the last packet among the entire packets. T_{SIFS} represents the time taken until the transmission/reception unit 111 receives the response message, for example, a clear-to-send (CTS) message, from the AP after transmitting the request message, for example, a ready-to-send (RTS) message, to the AP in order to acquire the transmit opportunity from the AP, or the time taken until the transmission/reception unit 111 receives the acknowledgement frame after transmitting the data frame. That is, T_{SIFS} represents the time from the acknowledgement request frame to the acknowledgement frame.

When one of the STAs associated with the AP intends to transmit data to the AP, other STAs cannot recognize the transmission of data to the AP. Therefore, since the STAs transmit data to the AP at the same time, collision occurs in data transmitted by different STAs. For this reason, the STA transmits the RTS message to the AP, and the AP receiving the RTS message transmits the CTS message to the STA associated with the AP.

All STAs receiving the CTS message from the AP postpone the data transmission. Also, the AP transmits the CTS message even to the STA having transmitted the RTS message. T_{ACK} represents the time taken until the STA receives the acknowledgement message from the AP after transmitting the data to the AP. T_{DIFS} represents the time until the transmit opportunity is determined after the STA completes the data transmission.

T_{BO} represents the time which the STA waits for in order to prevent the collision. The determination unit 115 determines the association with the predetermined AP among the scanned APs 110, 120 and 130, considering the usable power levels of the APs 110, 120 and 130 and the number of the associable STAs during the TXOP periods calculated by the calculation unit 113.

The determination unit 115 transmits the determined AP to the transmission/reception unit 111, and the transmission/reception unit 111 associates with the AP determined by the determination unit 115 and receives a communication service. The procedure in which the transmission/reception unit 111 receives the state information from the APs 110, 120 and 130 when the power levels used by the STA associated with the APs 110, 120 and 130 are not equal to one another will be described in more detail with reference to FIG. 4.

FIG. 4 is a view schematically illustrating the procedure in which the transmission/reception unit 111 receives the state information from the APs 110, 120 and 130 when the power levels used by the STA associated with the APs 110, 120 and 130 are not equal to one another.

Referring to FIG. 4, the transmission/reception unit 111 of the STA 100 scans the associable APs 110, 120 and 130 in order for association with the AP having the optimum state. A case in which the transmission/reception unit 111 of the STA 100 scans the AP 120 among the associable APs 110, 120 and 130 will be described below.

When the transmission/reception unit 111 scans the AP 120 by using the passive scanning scheme, the transmission/reception unit 111 requests the state information to the AP 120 by using the probe request message. When the power levels used by the STAs associated with the AP 120 are equal to one another, the AP 120 uses the probe response message to transmit to the transmission/reception unit 111 information indicating the usable power levels of the AP 120 and the number of the STAs associable with the AP 120, as illustrated in FIG. 2.

However, since the power levels used by the STAs 101, 102, 103, 104 and 105 associated with the AP 120 are not equal to one another, the AP 120 scans the STAs 101, 102, 103, 104 and 105 associated with the AP 120, and transmits the power levels used in the AP 120 by the STAs 101, 102, 103, 104 and 105. The method in which the AP 120 scans the STAs 101, 102, 103, 104 and 105 associated with the AP 120 is equal to the method in which the STA 100 of FIG. 2 scans the associable APs 110, 120 and 130 in order for the association with the AP having the optimum state.

That is, the AP 120 scans the STAs 101, 102, 103, 104 and 105 associated with the AP 120 by using the passive scanning scheme or the active scanning scheme. When the AP 120 scans the STAs 101, 102, 103, 104 and 105 associated with the AP 120 by using the passive scanning scheme, the AP 120 requests the power levels, which are used by the STAs 101, 102, 103, 104 and 105, to the STAs 101, 102, 103, 104 and 105 by using the probe request message.

The STAs 101, 102, 103, 104 and 105 receiving the request message transmit the requested information to the AP 120 by using the probe response message. The AP 120 transmits the information received from the STAs 101, 102, 103, 104 and 105 to the STA 100.

When the AP 120 scans the STAs 101, 102, 103, 104 and 105 associated with the AP 120 by using the active scanning scheme, the STAs 101, 102, 103, 104 and 105 contain their power levels, which are used in the AP 120, in a beacon message and transmit the beacon message to the AP 120. The AP 120 transmits the information received from the STAs 101, 102, 103, 104 and 105 to the STA 110.

The calculation unit 113 of the STA 100 calculates the TXOP period with respect to the AP 120 by using the received state information of the AP 120. The determination unit 115 determines the association with a predetermined AP among the scanned APs 110, 120 and 130, considering the usable power levels of the APs 110, 120 and 130 and the number of the associable STAs in the TXOP periods calculated by the calculation unit 113.

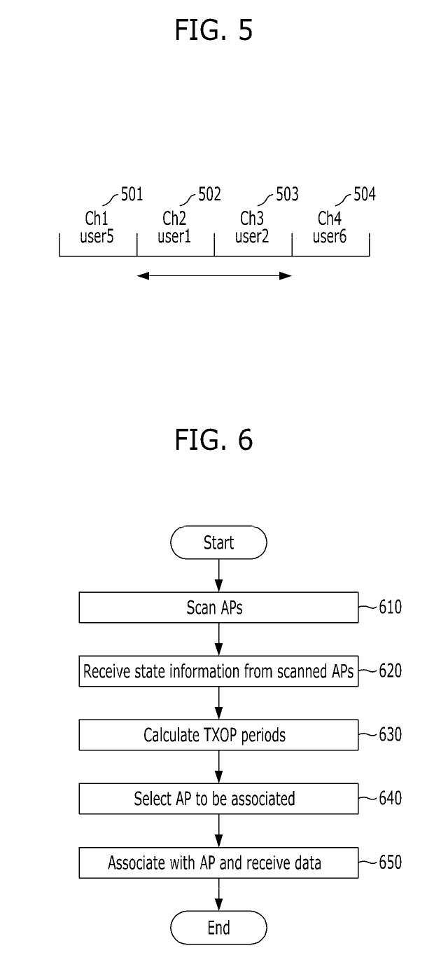

The predetermined AP determined by the determination unit 115 is transmitted to the transmission/reception unit 111, and the transmission/reception unit 111 associates with the predetermined AP determined by the determination unit 115 and receives a communication service. The procedure in which the transmission/reception unit 111 receives the state information from the APs 110, 120 and 130 when the power levels used by the STA associated with the APs 110, 120 and 130 including multiple channels are equal to one another will be described in more detail with reference to FIGS. 2 and 5.

FIG. 5 is a view illustrating a method for selecting a channel when the AP which the transmission/reception unit 111 intends to associate with uses multiple channels.

Referring to FIGS. 2 and 5, the APs 110, 120 and 130 of FIG. 2 include multiple channels 501, 502, 503 and 504 as illustrated in FIG. 5. First, the transmission/reception unit 111 of the STA 100 of FIG. 2 scans the associable APs 110, 120 and 130 in order for association with the AP having the optimum state, and receives the state information from the scanned APs 110, 120 and 130. The transmission/reception unit 111 may scan the associable APs 110, 120 and 130 by using the passive scanning scheme or the active scanning scheme.

More specifically, when the transmission/reception unit 111 scans the associable APs 110, 120 and 130 by using the passive scanning scheme, the transmission/reception unit 111 requests the state information to the APs 110, 120 and 130 by using the probe request message. The state information is information indicating the usable power levels of the APs 110, 120 and 130 and the number of the STAs associable with the APs 110, 120 and 130. The APs 110, 120 and 130 receiving the request message transmit the requested state information by using the probe response message.

The transmission/reception unit 111 receives the state information through the probe response message and transmits the state information to the calculation unit 113. The calculation unit 113 calculates the TXOP periods with respect to the APs 110, 120 and 130 by using the received state information of the APs 110, 120 and 130. The determination unit 115 determines the association with the predetermined AP among the scanned APs 110, 120 and 130, considering the usable power levels of the APs 110, 120 and 130 and the number of the associable STAs during the calculated TXOP periods.

Since the determined AP includes the multiple channels 501, 502, 503 and 504 as illustrated in FIG. 5, the associable multiple channels 501, 502, 503 and 504 are searched in order for the association with the channel having the optimum state among the multiple channels 501, 502, 503 and 504, and the state information is received from the searched multiple channels 501, 502, 503 and 504.

The STA calculates the TXOP periods with respect to the multiple channels 501, 502, 503 and 504 by using the state information received from the multiple channels 501, 502, 503 and 504, and determines the association with the predetermined channel among the searched multiple channels 501, 502, 503 and 504, considering the usable power levels of the multiple channels 501, 502, 503 and 504 and the number of the associable STAs during the TXOP periods. Then, the STA associates with the predetermined channel and receives a communication service.

When the power levels of the STA using the multiple channels 501, 502, 503 and 504 are not equal to one another, the predetermined AP receives the power levels of the STA using the multiple channels 501, 502, 503 and 504 through the procedure of FIG. 4. After the received power levels are transmitted to the STA 100, the STA 100 determines the association with the predetermined channel among the searched multiple channels 501, 502, 503 and 504, considering the usable power levels and the number of the associable STAs. Then, the STA 100 associates with the predetermined channel and receives a communication service. An association supporting method in a wireless communication system in accordance with an embodiment of the present invention will be described below in more detail.

FIG. 6 is a flowchart schematically illustrating an association supporting method in a wireless communication system in accordance with an embodiment of the present invention.

Referring to FIG. 6, an association supporting apparatus scans associable APs 110, 120 and 130 in order for association with an AP having an optimum state in step S610. At step S620, the association supporting apparatus receives state information from the scanned APs 110, 120 and 130. The state information is information indicating usable power levels of the APs 110, 120 and 130 and the number of STAs associable with the APs. Also, the association supporting apparatus may scan the associable APs 110, 120 and 130 by using a passive scanning scheme or an active scanning scheme.

More specifically, when the association supporting apparatus scans the associable APs 110, 120 and 130 by using the passive scanning scheme, it requests the state information to the APs by using a probe request message. The APs receiving the request message transmits the requested state information to the association supporting apparatus by using a probe response message. The association supporting apparatus receives the state information through the probe response message.

At step S630, the association supporting apparatus calculates TXOP periods with respect to the APs by using the received state information of the APs. The association supporting apparatus may calculate the TXOP periods with respect to the APs by using Equation 1 above. The detailed description of Equation 1 will be omitted.

At step S640, the association supporting apparatus determines the association with a predetermined AP among the scanned APs, considering the usable power levels of the APs and the associable STAs during the calculated TXOP periods. The predetermined AP is one of the scanned APs 110, 120 and 130 which has the optimum (minimum) TXOP period among the calculated TXOP periods.

At step S650, the association supporting apparatus associates with the determined AP and receives a communication service.

In accordance with the embodiments of the present invention, in the wireless communication system, the STA can be dynamically associated with the optimum AP, depending on the operation states of the plurality of APs, to thereby provide a communication service to a user at a high speed. Moreover, the plurality of STAs are associated with the optimum AP in distributed manner, depending on the operation states of the plurality of APs, thereby utilizing resources efficiently.

While the present invention has been described with respect to the specific embodiments, it will be apparent to those skilled in the art that various changes and modifications may be made without departing from the spirit and scope of the invention as defined in the following claims.

What is claimed is:

1. An association supporting apparatus in a wireless communication system, comprising:
a transmission/reception unit configured to scan associable access points (APs) among a plurality of APs existing in a plurality of station (STA) wireless networks, and receive state information from the scanned APs;
a calculation unit configured to calculate transmit opportunity (TXOP) periods with respect to the APs by using the received state information of the APs; and
a determination unit configured to determine a predetermined AP among the plurality of scanned APs, considering usable power levels of the APs and the number of associable STAs during the calculated TXOP periods.

2. The association supporting apparatus of claim 1, wherein the predetermined AP is an AP having a minimum TXOP period among the calculated TXOP periods.

3. The association supporting apparatus of claim 1, wherein the transmission/reception unit associates with the determined AP and receives a communication service.

4. The association supporting apparatus of claim 1, wherein the transmission/reception unit scans the associable APs among the plurality of APs by using a passive scanning scheme or an active scanning scheme.

5. The association supporting apparatus of claim 4, wherein the passive scanning scheme transmits a probe request message requesting the state information to the associable APs, and receives a probe response message including the state information from the AP receiving the probe request message.

6. The association supporting apparatus of claim 4, wherein the active scanning scheme receives a beacon message including the state information from the plurality of APs.

7. The association supporting apparatus of claim 5, wherein the state information includes usable power levels and the number of STAs associable with the predetermined AP during the TXOP period.

8. An association supporting method in a wireless communication system, comprising:
scanning associable APs among a plurality of APs existing in a plurality of STA wireless networks;
receiving state information from the scanned APs;
calculating TXOP periods with respect to the APs by using the received state information of the APs;
determining a predetermined AP among the plurality of scanned APs, considering usable power levels of the APs and the number of associable STAs during the calculated TXOP periods; and
associating with the determined AP and receiving a communication service.

9. The association supporting method of claim 8, wherein the predetermined AP is an AP having a minimum TXOP period among the calculated TXOP periods.

10. The association supporting method of claim 8, wherein the associable APs are scanned by using a passive scanning scheme or an active scanning scheme.

11. The association supporting method of claim 10, wherein the passive scanning scheme comprises:
transmitting a probe request message requesting the state information to the associable APs; and
receiving a probe response message including the state information from the AP receiving the probe request message.

12. The association supporting method of claim 10, wherein the active scanning scheme comprises receiving a beacon message including the state information from the plurality of APs.
